(19) United States
(12) Patent Application Publication
(10) Pub. No.: US 2018/0336605 A1
(43) Pub. Date: Nov. 22, 2018

(54) INTELLIGENT INTERACTIVE SHOPPING ASSISTANCE SYSTEM AND METHOD

(71) Applicant: Datalogic IP Tech, S.r.l., Bologna (IT)

(72) Inventor: Valentina Volta, Bologna (IT)

(21) Appl. No.: 15/539,594

(22) PCT Filed: Dec. 24, 2014
(86) PCT No.: PCT/IT2014/000349

§ 371 Date: Jun. 23, 2017

(51) Int. Cl. G06Q 30/06

(52) U.S. Cl. CPC G06Q 30/06

(57) ABSTRACT

Intelligent interactive shopping assistance (USA) systems that bridge the gap between in-store shopping and online shopping and facilitate the search and acquisition of products or services advertised through visual media and/or audio media. The USA system may receive composite captured data that includes goods or services related source data (e.g., video, image, audio) captured or sampled by a remotely located consumer processor-based device as well as specific consumer interest data signifying the consumer's interest in a particular good or service. In response to receiving the goods or services related source data and the consumer interest data, the USA system may analyze the data to recognize the particular good or service as well as the consumer's interest in the good or service. The USA may cause suitable actions to occur, such as causing the purchase of the good or service or causing information relating to the good or service to be sent to the consumer.

### BACKGROUND

### Technical Field

The present disclosure relates generally to electronic commerce, and more particularly to network-based intelligent shopping systems.

### Description of the Related Art

Networked or online shopping is a form of electronic commerce which allows consumers the ability to collect information about the product of interest or directly buy goods or services from a seller over a network, such as the Internet. Typically, consumers utilize a consumer processor-based device (e.g., tablet computer, smartphone, desktop computer, notebook computer) that executes a Web browser or application which provides the consumer with access to a seller's online storefront or shop. The term online shop suggests the physical analogy of buying products or services at a brick-and-mortar retailer or shopping center.

Generally, consumers may find a product or service of interest on the online store of the retailer directly or by searching among alternative vendors using a shopping search engine or an online marketplace. Once a particular product or service has been found, most online retailers use some sort of shopping cart software to allow the consumer to accumulate multiple items and to adjust quantities, similar to filling a physical shopping cart or basket in a conventional store. A “checkout” process may follow, in which payment and delivery information is collected. Some stores allow consumers to sign up for a permanent online account so that some or all of this information only needs to be entered once. The consumer may then receive an e-mail confirmation once the transaction is complete.

### BRIEF SUMMARY

A method of operation in a shopping assistance platform including at least one processor-based component having at least one nontransitory processor-readable medium communicatively coupled to the at least one processor-based component and which stores at least one of processor-executable instructions or data may be summarized as including receiving, by the at least one processor-based component, composite captured data from a consumer processor-based device of a consumer over at least one data communication channel, the composite captured data including captured good or service (GOS) source data and captured consumer interest data, the captured GOS source data captured by the consumer processor-based device and representative of at least one of an audio signal or an image signal that indicates a good or service, the captured consumer interest data captured by the consumer processor-based device and represents an interest of the consumer in the good or service; reviewing, by the at least one processor-based component, at least a portion of the received composite captured data to detect at least the good or service represented by the captured GOS source data and to detect the interest of the consumer represented in the captured consumer interest data; and causing, by the at least one processor-based component, at least one of a purchasing of the detected good or service or a sending of information concerning the good or service to the consumer processor-based device over the at least one data communication channel based at least in part on the reviewing of at least a portion of the received composite captured data. Reviewing at least a portion of the received composite captured data may include comparing, by the at least one processor-based component, at least one of the captured GOS source data or the captured consumer interest data to reference data stored in the at least one nontransitory processor-readable medium. Receiving composite captured data from a consumer processor-based device over at least one data communication channel may include receiving captured GOS source data representative of a human-intelligible audio signal, and reviewing at least a portion of the received composite captured data may include determining, by the at least one processor-based component, at least one textual representation of the audio signal. Reviewing at least a portion of the composite captured data may include comparing the determined at least one textual representation of the audio signal to reference data stored in the at least one nontransitory processor-readable medium. Receiving composite captured data from a consumer processor-based device over at least one data communication channel may include receiving captured GOS source data representative of a human-intelligible image signal, and reviewing at least a portion of the received composite captured data may include determining, by the at least one processor-based component, at least one graphical insignia present in the image signal indicative of the good or service. Reviewing at least a portion of the received composite captured data may include comparing the determined at least one graphical insignia to reference data stored in the at least one nontransitory processor-readable medium. Receiving composite captured data from a consumer processor-based device over at least one data communication channel may include receiving captured GOS source data representative of a human-intelligible image signal, and reviewing at least a portion of the received composite captured data may include determining, by the at least one processor-based component, one or more features of the image signal, and comparing the determined one or more features to reference features stored in the at least one nontransitory processor-readable medium. Receiving composite captured data from the consumer processor-based device may include receiving audio data representative of a voice instruction of the consumer captured by the consumer processor-based device.

The method may further include determining, by the at least one processor-based component, at least one textual representation of the audio data representative of the voice instruction; and comparing, by the at least one processor-based component, the determined at least one textual representation of the audio data to reference data stored in the at least one nontransitory processor-readable medium to identify the voice instruction of the consumer. Receiving composite captured data from the consumer processor-based device may include receiving consumer interest data obtained from the consumer via a user interface component communicatively coupled to the consumer processor-based device. Receiving composite captured data from the consumer processor-based device may include receiving consumer interest data obtained from the consumer via a user interface component communicatively coupled to the consumer processor-based device that receives contactless human motions as input. Causing a purchasing of the good or service may include sending, by the at least one processor-based component, purchase order data to a merchant processor-based device over the at least one data communication channel. Sending purchase order data to a merchant processor-based device over the at least one data communication channel may include sending at least one of contact information, shipping information, or payment information to the merchant processor-based device over the at least one data communication channel. Causing a purchasing of the at least one good or service may include sending, by the at least one processor-based component, payment information to a payment processor-based device over the at least one data communication channel. Receiving composite captured data from a consumer processor-based device over at least one data communication channel may include receiving advertising source data captured by the consumer processor-based device, the advertising source data representative of human-intelligible advertising content. Receiving advertising source data may include receiving advertising source data representative of human-intelligible advertising content, the advertising content captured by at least one of an acoustic sensor or an image sensor of the consumer processor-based device. Receiving composite captured data from a consumer processor-based device over at least one data communication channel may include receiving composite captured data over at least one wireless data communication channel from at least one of a smartphone, notebook computer or a tablet computer. Receiving composite captured data from a consumer processor-based device over at least one data communication channel may include receiving consumer interest data including at least one of a request for a purchasing of the good or service or a request for information concerning the good or service.

An interactive shopping assistance system may be summarized as including at least one processor-based component; and at least one nontransitory processor-readable medium communicatively coupled to the at least one processor-based component and which stores at least one of processor-executable instructions or data that when executed by the at least one processor-based component of the online shopping system, cause the at least one processor-based component to: receive composite captured data from a consumer processor-based device of a consumer over at least one data communication channel, the composite captured data including captured good or service (GOS) source data and captured consumer interest data, the captured GOS source data captured by the consumer processor-based device and representative of at least one of an audio signal or an image signal that indicates a good or service, the captured consumer interest data captured by the consumer processor-based device and represents an interest of the consumer in the good or service; review at least a portion of the received composite captured data to detect at least the good or service represented by the captured GOS source data and to detect the interest of the consumer represented in the captured consumer interest data; and cause at least one of a purchasing of the detected good or service or a sending of information concerning the good or service to the consumer processor-based device over the at least one data communication channel based at least in part on the review of at least a portion of the received composite captured data. The at least one processor-based component may compare at least one of the captured GOS source data or the captured consumer interest data to reference data stored in the at least one nontransitory processor-readable medium. The at least one processor-based component may receive captured GOS source data representative of a human-intelligible audio signal; and may determine at least one textual representation of the audio signal. The at least one processor-based component may compare the determined at least one textual representation of the audio signal to reference data stored in the at least one nontransitory processor-readable medium. The at least one processor-based component may receive captured GOS source data representative of a human-intelligible image signal; and may determine at least one graphical insignia present in the image signal indicative of the good or service. The at least one processor-based component may compare the determined at least one graphical insignia to reference data stored in the at least one nontransitory processor-readable medium. The at least one processor-based component may receive captured GOS source data representative of a human-intelligible image signal; may determine one or more features of the image signal; and may compare the determined one or more features to reference features stored in the at least one nontransitory processor-readable medium. The at least one processor-based component may receive audio data representative of a voice instruction of the consumer captured by the consumer processor-based device. The at least one processor-based component may determine at least one textual representation of the audio data representative of the voice instruction; and may compare the determined at least one textual representation of the audio data to reference data stored in the at least one nontransitory processor-readable medium to identify the voice instruction of the consumer. The at least one processor-based component may receive consumer interest data obtained from the consumer via a graphical user interface component communicatively coupled to the consumer processor-based device. The at least one processor-based component may receive consumer interest data obtained from the consumer via a gesture user interface component that receives contactless human motions as input. The at least one processor-based component may send purchase order data to a merchant processor-based device over the at least one data communication channel. The at least one processor-based component may send at least one of contact information, shipping information, or payment information to the merchant processor-based device over the at least one data communication channel. The at least one processor-based component may send payment information to a payment processor-based device over the at least one data communication channel. The at least one processor-based component may receive advertising source data captured by the consumer processor-based device, the advertising source data representative of human-intelligible advertising content. The human-intelligible advertising content may be captured by at least one of an acoustic sensor or an image sensor of the consumer processor-based device. The at least one processor-based component may receive composite captured data over at least one wireless data communication channel from at least one of a smartphone, notebook computer or a tablet computer. The at least one processor-based component may further include receive consumer interest data including at least one of a request for a purchasing of the good or service or a request for information concerning the good or service.

A method of operation in a shopping assistance platform including a consumer processor-based device of a consumer having at least one processor, at least one capture component communicatively coupled to the at least one processor, and at least one nontransitory processor-readable medium communicatively coupled to the at least one processor and which stores at least one of processor-executable instructions or data may be summarized as including capturing, by the at least one capture component, composite captured data which includes good or service (GOS) source data and consumer interest data, the GOS source data representative of at least one of an audio signal or an image signal that indicates a good or service, the consumer interest data represents an interest of the consumer in the good or service; and sending, by the at least one processor, the composite captured data to a processor-based shopping control system over at least one data communication channel, the processor-based shopping control system reviewing at least a portion of the composite captured data to detect at least the good or service represented by the captured GOS source data and to detect the interest of the consumer represented in the captured consumer interest data.

The method may further include receiving, by the at least one processor from the processor-based shopping control system, at least one of a purchase confirmation for the good or service or information concerning the good or service over the at least one data communication channel based at least in part on the review of at least a portion of the composite captured data by the processor-based shopping control system; and presenting, by the at least one processor, the received at least one of a purchase confirmation or information concerning the good or service via an output component of the consumer processor-based device. The at least one capture component may include an audio capture component communicatively coupled to the consumer processor-based device, and capturing composite captured data may include capturing a human-intelligible audio signal produced by an acoustic output component of a media player device as the GOS source data. The at least one capture component may include an audio capture component communicatively coupled to the consumer processor-based device, and capturing composite captured data may include capturing a spoken sound of the consumer as the consumer interest data. The at least one capture component may include an image capture component communicatively coupled to the consumer processor-based device, and capturing composite captured data may include capturing at least one image as the GOS source data. The at least one capture component may include a graphical user interface component communicatively coupled to the consumer processor-based device, and capturing composite captured data may include capturing consumer interest data via the graphical user interface component. The at least one capture component comprises a gesture user interface component that may receive contactless human motions as input, and capturing composite captured data may include capturing consumer interest data via the gesture user interface component.

The method may further include sending, by the at least one processor, an identifier to the processor-based shopping control system over at least one data communication channel, the identifier pertaining to at least one of the consumer or the consumer processor-based device. Capturing composite captured data may include capturing, via an image capture component of the consumer processor-based device, at least one of an image of a display of a processor-based device, an image of an object, or an image of printed media. Sending the composite captured data to a processor-based shopping control system may include wirelessly sending the composite captured data to a processor-based shopping control system over at least one data communication channel. Capturing composite captured data may include capturing consumer interest data that includes at least one of a request for a purchasing of the good or service, a request for available discounts concerning the good or service, or a request for information concerning the good or service.

A consumer processor-based device may be summarized as including at least one processor; at least one capture component communicatively coupled to the at least one processor; and at least one nontransitory processor-readable medium communicatively coupled to the at least one processor and which stores at least one of processor-executable instructions or data that when executed by the at least one processor, cause the at least one processor to: cause the at least one capture component to capture composite captured data which includes good or service (GOS) source data and consumer interest data, the GOS source data representative of at least one of an audio signal or an image signal that indicates a good or service, the consumer interest data represents an interest of the consumer in the good or service; and send the composite captured data to a processor-based shopping control system over at least one data communication channel, the processor-based shopping control system reviews at least a portion of the composite captured data to detect at least the good or service represented by the captured GOS source data and to detect the interest of the consumer represented in the captured consumer interest data.

The consumer processor-based device may further include at least one output component, wherein the at least one processor: receives from the processor-based shopping control system at least one of a purchase confirmation for the good or service or information concerning the good or service over the at least one data communication channel based at least in part on the review of at least a portion of the composite captured data by the processor-based shopping control system; and presents the received at least one of a purchase confirmation or information concerning the good or service via the output component. The at least one capture component may include an audio capture component, and wherein the at least one processor may cause the audio capture component to capture a human-intelligible audio signal produced by an acoustic output component of a media player device as the GOS source data. The at least one capture component may include an audio capture component, and wherein the at least one processor may cause the audio capture component to capture a spoken sound of the consumer as the consumer interest data. The at least one capture component may include an image capture component, and wherein the at least one processor may cause the image capture component to capture at least one image as the GOS source data. The at least one capture component may include a graphical user interface component, and wherein the at least one processor may cause the graphical user interface component to capture consumer interest data. The at least one capture component may include a gesture user interface component that receives contactless human motions as input. The at least one processor may send an identifier to the processor-based shopping control system over at least one data communication channel, the identifier pertaining to at least one of the consumer or the consumer processor-based device. The at least one capture component may include an image capture component, and wherein the at least one processor may cause the image capture component to capture at least one of an image of a display of a processor-based device, an image of an object, or an image of printed media.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an environment in which an intelligent interactive shopping assistance system may operate, according to at least one illustrated embodiment.

FIG. 2A is a functional block diagram of a shopping assistance control system of the intelligent interactive shopping assistance system of FIG. 1, according to at least one illustrated embodiment.

FIG. 2B is a functional block diagram of a consumer processor-based device of the intelligent interactive shopping assistance system of FIG. 1, according to at least one illustrated embodiment.

FIG. 3A is a block diagram showing an image detector component of the shopping assistance control system of FIG. 2A, according to at least one illustrated embodiment.

FIG. 3B is a block diagram showing an audio detector component of the shopping assistance control system of FIG. 2A, according to at least one illustrated embodiment.

FIG. 4 is a flow diagram showing a method of operation of an intelligent interactive shopping assistance system to provide an interactive shopping experience for a consumer, according to at least one illustrated embodiment.

FIG. 5 is a flow diagram showing a method of operation of a consumer processor-based device to capture source data pertaining to a good or service and consumer interest data pertaining to a consumer's interest in the good or service, according to at least one illustrated embodiment.

FIG. 6 is a flow diagram showing a method of operation of a shopping assistance control system to provide an interactive shopping experience for a consumer, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the various embodiments have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the embodiments.

One or more implementations of the present disclosure relate to providing intelligent interactive shopping assistance (IISA) systems that bridge the gap between in-store shopping and online shopping and facilitate the search and acquisition of products or services advertised through visual media (e.g., video, images, physical products, print media) and/or audio media (e.g., terrestrial radio, satellite radio, webcast). In some implementations, the IISA system may receive composite captured data that includes goods or services (GOS) source data (e.g., video, image, audio) captured or sampled by a remotely located consumer processor-based device of a consumer as well as specific consumer interest data pertaining to the consumer's interest in the goods or services.

The captured GOS source data may identify one or more goods and services. For example, the GOS source data may include an image or sequence of images (e.g., video) of a television screen displaying a particular product (e.g., car, yogurt) during an advertisement segment with or without the associated audio from the television presentation. The consumer interest data may define a consumer's particular interest in the research or purchase of selected goods or services or similar goods and services with additional features and/or characteristics, a consumer's interest in obtaining advertised benefits or discounts for goods or services, or consumer commands to acquire selected goods or services. For example, the captured consumer interest data may include user spoken audio data captured by a microphone of a consumer processor-based device representative of a voice command of the consumer, such as the voice commands: “Purchase yogurt,” or “How many calories are in the yogurt shown on the TV.” The consumer interest data may also be captured using other types of input devices, such as a touch screen, keyboard, mouse, camera, human motion or gesture recognition component, etc. For example, the consumer may type an instruction or query one a touch screen using natural language or determined commands. In response to receiving the captured GOS source data and the consumer interest data, the IISA system may autonomously cause a suitable action to occur. Such actions may include causing the purchase and/or delivery of a good or service, causing information relating to a good or service to be provided to the consumer, etc.

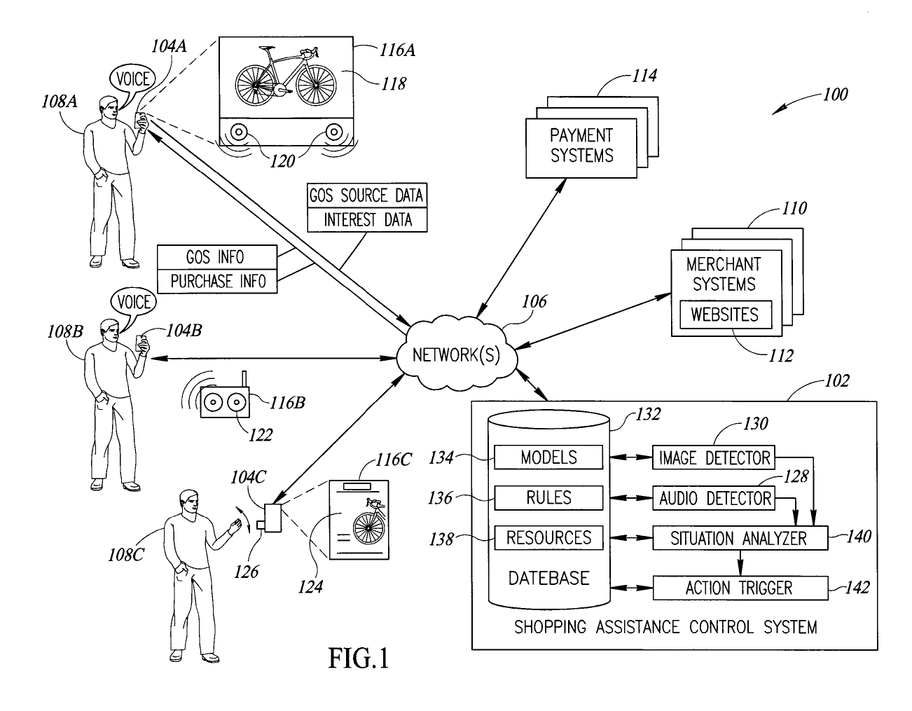

FIG. 1 shows an example networked environment for use in providing an IISA system 100. As illustrated in FIG. 1, the networked environment may include a shopping assistance control system (“control system”) 102 communicatively coupled to a plurality of consumer processor-based devices 104A-C (collectively “consumer processor-based devices 104”) via one or more communications channels, for instance communications networks 106 (e.g., LAN, WAN, Internet, Worldwide Web, cellular network, USB®, Bluetooth®, WiFi®, NFC). The consumer processor-based devices 104A-C are associated with respective consumers 108A-C. The consumer processor-based devices 104 may be identified to the control system 102 by one or more identifiers which may include, for example, a device identifier, a user account identifier, a device internet protocol (IP) address, a device media access control (MAC) address, a device carrier, or a device phone number. In some implementations, the control system 102 may also be coupled to one or more merchant systems 110 and associated websites 112, one or more payment systems 114, or other systems via the one or more communications networks 106 using any suitable communication protocols.

FIG. 1 depicts a plurality of sources 116 of advertising data that may be captured by the consumer processor-based devices 104. Specifically, proximate the consumer 108A and the consumer processor-based device 104A is a television 116A including a display 118 which provides images and video and speakers 120 which provide audio. Such images, video, and/or audio may be captured by a capture component (e.g., camera, microphone) of the consumer processor-based device 104A. Proximate the consumer 108B and the consumer processor-based device 104B is a radio 116B that plays audio advertisements through speakers 122 which may be captured by an audio capture component (e.g., microphone) of the consumer processor-based device 104B. Proximate the consumer 108C and consumer processor-based device 104C is a magazine 116C that includes an advertisement page 124 depicting a product which may be captured by an image capture component (e.g., camera) of the consumer processor-based device 104C.

The consumer processor-based devices 104 may also receive consumer interest data from the consumers 108 through various capture components including, but not limited to, an image capture component (e.g., camera), an audio capture component (e.g., microphone), a graphical user interface (e.g., touchscreen, keyboard), a gesture or motion capturing user interface component, a scanner, a global positioning system (GPS) receiver, etc. For example, the consumer processor-based device 104C shown in FIG. 1 includes a human motion sensor 126 that receives motions or gestures of the consumer 108C as input. An example human motion sensor is a sensor offered by Leap Motion, Inc. of San Francisco, Calif.

The shopping assistance control system 102 may include an audio detector component 128 and an image detector component 130. As discussed further below, the audio detector component 128 and the image detector component 130 may operate independently or jointly to analyze GOS source data and consumer interest data captured by consumer processor-based devices 104 to recognize goods or services depicted by the GOS source data and to recognize instructions or queries of the consumers 108. The audio detector component 128 and the image detector component 130 may be communicatively coupled to a nontransitory computer- or processor-readable medium or database 132 that stores one or more detection algorithms or models 134, rules 136, or resources 138, as discussed further below. In some implementations, the audio detector 128 may be divided into a detector that detects spoken words (e.g., commands, queries) by a consumer and a detector that detects advertisement source data pertaining to goods and services, such as audio from a radio commercial or the audio track from a television commercial.

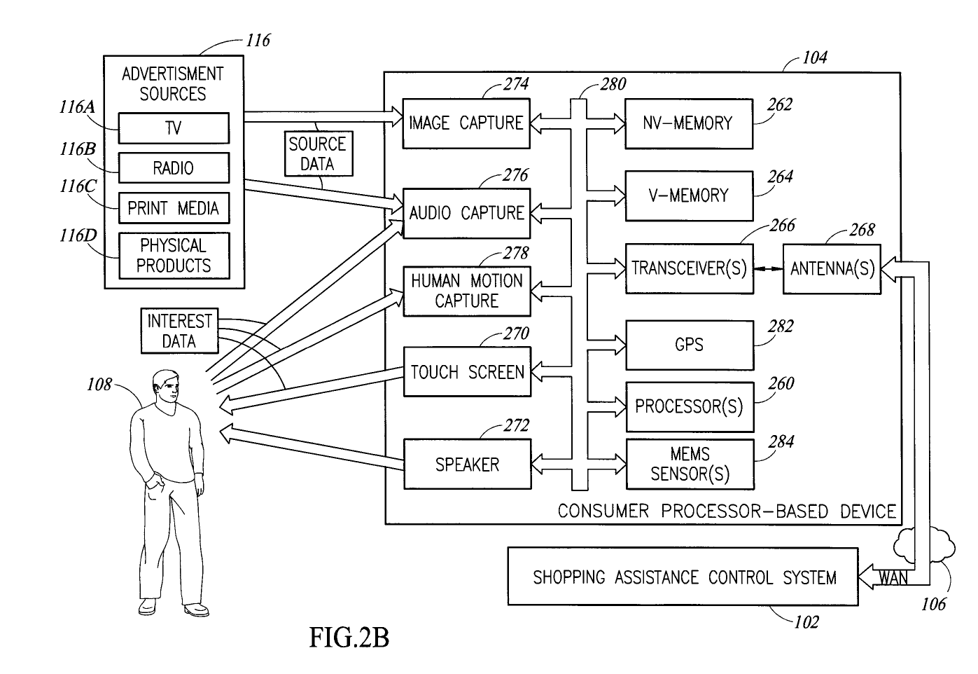

For example, the audio detector 128 may include a speech recognition engine, a natural language parser, a semantic web, matching or relevance models, etc. The image detector 130 may be capable of recognizing objects in captured images and decoding graphical insignia, such as alphanumeric characters, machine-readable symbols, watermarking codes, etc. The audio detector 128 and the image detector 130 are discussed in further detail below with reference to FIGS. 3A and 3B.

The control system 102 may also include a situation analyzer component 140 that generates a list of pertinent objectives based at least in part on the analyzed GOS source data and consumer interest data. Such objectives may include, for example, locating additional information about a good or service, placing a purchase order for a good or service, causing a delivery of a good, or the like.

The control system 102 may also include an action trigger component 142 that generates a list of actions to achieve the determined objectives and, in some implementations, causes such actions to be performed. For example, the action trigger component 142 may obtain information about a good or service by accessing resources 138 relating to goods or services stored in the database 132 and/or may access resources stored in other systems, such as merchant systems 110, search engines, product databases, product review systems, etc. The action trigger component 142 may send such information relating to goods or services to the consumer processor-based device 104 for presentation to the consumer 108.

As another example, the action trigger component 142 may cause a purchase of a good or service for the consumer 108 through one or more of the merchant systems 110. In some implementations, the database 132 may store relevant account information for the consumers 108 such as payment information (e.g., payment card information, bank account information), contact information, shipping information, merchant account information, or the like, which may be used to cause a good or service to be purchased and/or delivered (e.g., shipped, transmitted) to the consumer. The functionality of the various components of the control system 102 is further discussed below with reference to FIGS. 3A, 3B and 4-6.

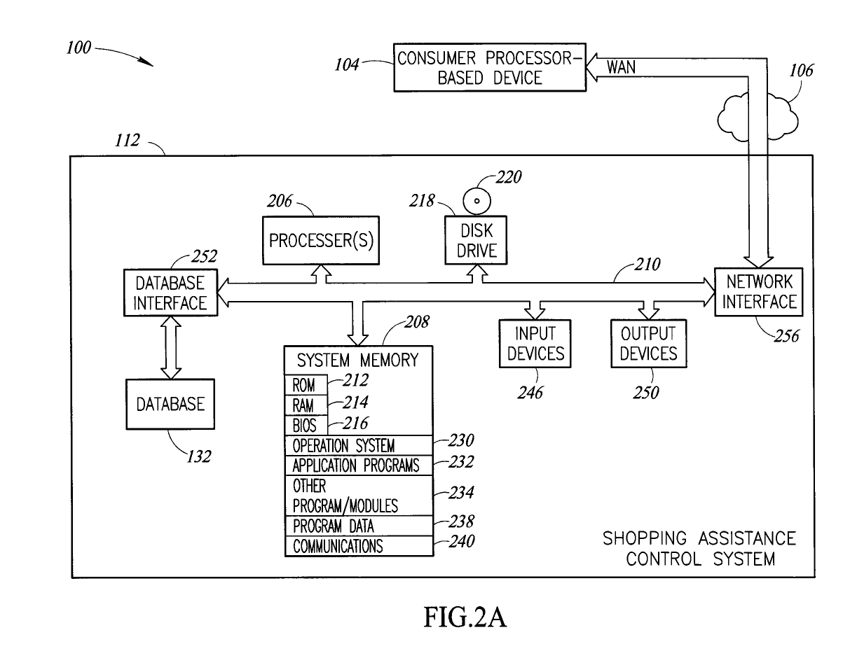

FIGS. 2A, 2B and the following discussion provide a brief, general description of the components forming the IISA system 100 including the shopping assistance control system 102 and the consumer processor-based device 104 in which the various illustrated embodiments can be implemented. The IISA system 100 may, for example, implement the various functions and operations discussed immediately above in reference to FIG. 1. Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system or processor-based device configurations, including handheld devices, for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The control system 102 may take the form of a PC, server, or other computing system executing logic or other machine executable instructions which may advantageously improve networked shopping systems. The control system 102 includes one or more processors 206, a system memory 208 and a system bus 210 that couples various system components including the system memory 208 to the processor 206. The control system 102 will at times be referred to in the singular herein, but this is not intended to limit the embodiments to a single system, since in certain embodiments, there will be more than one control system 102 or other networked computing device involved. Non-limiting examples of commercially available systems include, but are not limited to, microprocessors based on x86 or RISC architectures from Intel Corporation, AMD, TI, STM, Fujitsu, OKI, Siemens, Cyrix, Intersil, C&T, Hewlett-Packard Company, etc.

The processor 206 may be any logic processing unit, such as one or more central processing units (CPUs), multicores microprocessors, digital signal processors (DSPs), graphics processors (GPUs), application-specific integrated circuits (ASICs), field programmable gate arrays (FPGAs), etc. Unless described otherwise, the construction and operation of the various blocks shown in FIGS. 2A and 2B are of conventional design. As a result, such blocks need not be described in further detail herein, as they will be understood by those skilled in the relevant art.

The system bus 210 can employ any known bus structures or architectures. The system memory 208 includes read-only memory (“ROM”) 212 and random access memory (“RAM”) 214. A basic input/output system (“BIOS”) 216, which may be incorporated into at least a portion of the ROM 212, contains basic routines that help transfer information between elements within the control system 102, such as during start-up. Some embodiments may employ separate buses for data, instructions and power.

The control system 102 also may include one or more disk drives 218 for reading from and writing to one or more nontransitory computer- or processor-readable media 220 (e.g., hard disk, magnetic disk, optical disk, flash memory). The disk drive 218 may communicate with the processor 206 via the system bus 210. The disk drive 218 may include interfaces or controllers (not shown) coupled between such drives and the system bus 210, as is known by those skilled in the art. The drives 218 and their associated nontransitory computer- or processor-readable media 220 provide nonvolatile storage of computer-readable instructions, data structures, program modules and other data for the control system 102. Those skilled in the relevant art will appreciate that other types of computer-readable media may be employed to store data accessible by a computer.

Program modules can be stored in the system memory 208, such as an operating system 230, one or more application programs 232, other programs or modules 234, and program data 238.

The application program(s) 232 may include logic capable of providing the functionality described herein. For example, applications programs 232 may implement some or all of the components of the control system shown in FIG. 1.

The system memory 208 may include communications programs 240 that permit the control system 102 to access and exchange data with other networked systems or components, such as the consumer processor-based device 104, the merchant systems 110, the payment systems 114, and/or other computing devices.

While shown in FIG. 2A as being stored in the system memory 208, the operating system 230, application programs 232, other programs/modules 234, program data 238 and communications programs 240 can be stored on the nontransitory computer- or processor-readable media 220 or other nontransitory computer- or processor-readable media.

Users can enter commands (e.g., system maintenance, upgrades, etc.) and information (e.g., parameters, equations, models, etc.) into the control system 102 using one or more communicably coupled input devices 246 such as a touch screen or keyboard, a pointing device such as a mouse, and/or a push button. Other input devices can include a microphone, joystick, game pad, tablet, scanner, biometric scanning device, gesture detection device, etc. These and other input devices may be connected to the processor(s) 206 through an interface such as a universal serial bus (“USB”) interface that couples to the system bus 210, although other interfaces such as a parallel port, a game port or a wireless interface or a serial port may be used. One or more output devices 250, such as a monitor or other display device, may be coupled to the system bus 210 via a video interface, such as a video adapter. In at least some instances, the input devices 246 and the output devices 250 may be located proximate the control system 102, for example when the system is installed at the system user's premises. In other instances, the input devices 246 and the output devices 250 may be located remote from the control system 102, for example when the system is installed on the premises of a service provider.

In some implementations, the control system 102 uses one or more of the logical connections to optionally communicate with one or more remote computers, servers and/or other devices via one or more communications channels, for example, one or more networks 106. These logical connections may facilitate any known method of permitting computers to communicate, such as through one or more LANs, PANs and/or WANs. Such networking environments are known in wired and wireless enterprise-wide computer networks, intranets, extranets, and the Internet.

In some implementations, a network port or interface 256, communicatively linked to the system bus 210, may be used for establishing and maintaining communications over the communications network 106. Further, a database interface 252, which is communicatively linked to the system bus 210, may be used for establishing communications with the nontransitory processor-readable storage medium or database 132, which may be a part of the control system 102 or at least in operative communication therewith. For example, the database 132 may include a repository for storing information regarding parameters, models, product information, audio data, image data, etc. In some embodiments, the database interface 252 may communicate with the database 132 via the networks 106.

In the IISA system 100, program modules, application programs, or data, or portions thereof, can be stored in one or more computing systems. Those skilled in the relevant art will recognize that the network connections shown in FIGS. 2A and 2B are only some examples of ways of establishing communications between computers, and other connections may be used, including wirelessly. In some embodiments, program modules, application programs, or data, or portions thereof, can even be stored in other computer systems or other devices (not shown).

For convenience, the processor 206, system memory 208, network interface 256 and devices 246, 250 are illustrated as communicatively coupled to each other via the system bus 210, thereby providing connectivity between the above-described components. In alternative embodiments, the above-described components may be communicatively coupled in a different manner than illustrated in FIGS. 2A and 2B. For example, one or more of the above-described components may be directly coupled to other components, or may be coupled to each other, via intermediary components (not shown). In some embodiments, system bus 210 is omitted and the components are coupled directly to each other using suitable connections.

FIG. 2B shows various components of the consumer processor-based device 104 according to at least some implementations. The consumer processor-based device 104 may include any device, system or combination of systems and devices having at least wired or wireless communications capabilities. In many instances, the consumer processor-based device 104 includes additional devices, systems, or combinations of systems and devices capable of providing graphical data display capabilities. Examples of such consumer processor-based devices 104 can include without limitation, cellular telephones, smart phones, tablet computers, desktop computers, laptop computers, ultraportable or netbook computers, personal digital assistants, handheld devices, set-top boxes, and the like.

The consumer processor-based device 104 may include one or more processors 260 and nontransitory computer- or processor-readable media or memory, for instance one or more non-volatile memories 262 such as read only memory (ROM) or FLASH memory and/or one or more volatile memories 264 such as random access memory (RAM).

The consumer processor-based device 104 may include one or more transceivers or radios 266 and associated antenna(s) 268. For example, the consumer processor-based device 104 may include one or more cellular transceivers or radios, one or more WiFi® transceivers or radios, and one or more BLUETOOTH® transceivers or radios, along with associated antennas. The consumer processor-based device 104 may further include one or more wired interfaces (not shown) that utilize parallel cables, serial cables, or wireless channels capable of high speed communications, for instance, via one or more of FireWire®, Universal Serial Bus® (USB), Thunderbolt®, or Gigabyte Ethernet®, for example.

The consumer processor-based device 104 may include a user input/output subsystem, for example including a touchscreen or touch sensitive display device 270 and one or more speakers 272. The touchscreen or touch sensitive display device 270 can include any type of touchscreen including, but not limited to, a resistive touchscreen or a capacitive touchscreen. The touchscreen or touch sensitive display device 270 may present a graphical user interface, for example in the form of a number of distinct screens or windows, which include prompts and/or fields for selection. The touchscreen or touch sensitive display device 270 may present or display individual icons and controls, for example virtual buttons or slider controls and virtual keyboard or key pads which are used to communicate instructions, commands, and/or data. While not illustrated, the user interface may additionally or alternatively include one or more additional input or output devices, for example an alphanumeric keypad, a QWERTY keyboard, a joystick, scroll wheel, touchpad or similar physical or virtual input device.

The consumer processor-based device 104 may include one or more image capture devices 274, for example, cameras with suitable lenses, and optionally one or more flash or lights for illuminating a field of view to capture images. The image capture device(s) 274 may capture still digital images or moving or video digital images. Image information may be stored as files via the non-volatile memory 262, for example.

The consumer processor-based device 104 may include one or more audio capture devices 276, for example, microphones to capture audio such as speech or music played in an advertisement.

The consumer processor-based device 104 may also include a human motion capture device or component 278 that receives motions or gestures of the consumer as input. As noted above, the consumer processor-based device 104 may include a sensor offered by Leap Motion, Inc. of San Francisco, Calif., for example.

Some or all of the components within the consumer processor-based device 104 may be communicably coupled using at least one bus 280 or similar structure adapted to transferring, transporting, or conveying data between the devices, systems, or components used within the consumer processor-based device 104. The bus 280 can include one or more serial communications links or a parallel communications link such as an 8-bit, 16-bit, 32-bit, or 64-bit data bus. In some embodiments, a redundant bus (not shown) may be present to provide failover capability in the event of a failure or disruption of the primary bus 280.

The processor(s) 260 may include any type of processor (e.g., ARM Cortext-A8, ARM Cortext-A9, Snapdragon 600, Snapdragon 800, NVidia Tegra 4, NVidia Tegra 4i, Intel Atom Z2580, Samsung Exynos 5 Octa, Apple A7, Motorola X8) adapted to execute one or more machine executable instruction sets, for example a conventional microprocessor, a reduced instruction set computer (RISC) based processor, an application specific integrated circuit (ASIC), digital signal processor (DSP), or similar. Within the processor(s) 260, a non-volatile memory may store all or a portion of a basic input/output system (BIOS), boot sequence, firmware, startup routine, and communications device operating system (e.g., iOS®, Android®, Windows® Phone, Windows® 8, and similar) executed by the processor 260 upon initial application of power. The processor(s) 260 may also execute one or more sets of logic or one or more machine executable instruction sets loaded from the volatile memory 264 subsequent to the initial application of power to the processor 260. The processor 260 may also include a system clock, a calendar, or similar time measurement devices.

One or more geolocation devices, for example a global positioning system (GPS) receiver 282 and one or more position sensing devices 284 (e.g., one or more microelectromechanical systems or “MEMS” accelerometers, gyroscopes, magnetometers, etc.) may be communicably coupled to the processor 260 to provide additional functionality, such as geolocation data, three-dimensional position data, motion detection and input, tilt measurement, screen rotation, etc.

The transceivers or radios 266 can include any device capable of transmitting and receiving communications via electromagnetic energy.

Non-limiting examples of cellular communications transceivers or radios 266 include a CDMA transceiver, a GSM transceiver, a 3G transceiver, a 4G transceiver, an LTE transceiver, and any similar current or future developed consumer processor-based device transceiver having at least one of a voice telephony capability or a data exchange capability. In at least some instances, the cellular transceivers or radios 266 can include more than one interface. For example, in some instances, the cellular transceivers or radios 266 can include at least one dedicated, full- or half-duplex, voice call interface and at least one dedicated data interface. In other instances, the cellular transceivers or radios 266 can include at least one integrated interface capable of contemporaneously accommodating both full- or half-duplex voice calls and data transfer.

Non-limiting examples of WiFi® transceivers or radios 266 include various chipsets available from Broadcom, including BCM43142, BCM4313, BCM94312MC, BCM4312, and chipsets available from Atmel, Marvell, or Redpine. Non-limiting examples of Bluetooth® transceivers or radios 266 include various chipsets available from Nordic Semiconductor, Texas Instruments, Cambridge Silicon Radio, Broadcom, and EM Microelectronic.

As noted, nontransitory computer- or processor-readable media can include non-volatile memory 262 and in some embodiments may include volatile memory 264 as well. At least a portion of the memory may be used to store one or more processor executable instruction sets for execution by the processor 260. In some embodiments, all or a portion of the memory may be disposed within the processor 260, for example in the form of a cache. In some embodiments, the memory may be supplemented with one or more slots configured to accept the insertion of one or more removable memory devices such as a secure digital (SD) card, a compact flash (CF) card, a universal serial bus (USB) memory “stick,” or the like.

In at least some implementations, one or more sets of logic or machine executable instructions providing applications or “apps” executable by the processor 260 may be stored in whole or in part in at least a portion of the memory 262, 264. In at least some instances, the applications may be downloaded or otherwise acquired by the end user, for example using an online marketplace such as the Apple App Store, Amazon Marketplace, or Google Play marketplaces. In some implementations, such applications may start up in response to selection of a corresponding user selectable icon by the user or consumer. The application can facilitate establishing a data link between the consumer processor-based device 104 and the interactive shopping control system via the transceivers or radios 266 and communication networks 106.

As discussed in more detail below, the application(s) may include logic or instructions to provide the end user with access to a number of graphical screens or windows with prompts, fields, and other user interface structures that allow the user or consumer to purchase or obtain information pertaining to goods or services via the control system 102. Such may include, for example, logic or machine executable instructions for various screens or windows.

FIGS. 3A and 3B are block diagrams of non-limiting example implementations of the image detector 130 and the audio detector 128, respectively, of the control system 102 shown in FIG. 1. Referring first to FIG. 3A, the image detector 130 receives image data 302 from a consumer processor-based device through a wired or wireless data communications channel or network. As discussed above, the image data 302 may be an image or video depicting a good or service captured by the consumer using the consumer processor-based device. For example, the image data 302 may be a digital representation of a bicycle, as depicted in the display of the television 116A shown in FIG. 1.

Using an image feature extractor 304, the image detector 130 may generate image feature value data for the image data 302. The image feature value data may be numerical scores that represent visual characteristics of at least a portion of the image represented by the image data 302. The image features may include color, edges, ridges, blobs, texture, saturation, or other characteristics. Example methods that may be used to extract values of the image features include methods for generating gradient location and orientation histograms, scale-invariant feature transforms (SIFT), edge detection, corner detection, blurring, and speeded up robust features (SURF) detectors.

A trained image-matching model 306 receives the image feature data from the image feature extractor 304. In some implementations, the trained image matching model 306 is trained (e.g., using a machine learning process) on labeled images of goods and services acquired from one or more resources. Such resources of labeled images may include, but are not limited to, product databases, merchant or manufacturer websites, search engines, content delivery systems, or images previously captured by consumer processor-based devices. For example, a product database accessible by the control system 102 (FIG. 1) may include images of products and associated text providing product information, such as product name, description, prices, sellers, reviews, ratings, etc. As another example, the image-matching model 306 may receive images of products previously captured by consumer-processor based devices 104 (FIG. 1) and analyzed and labeled by the image detector 130. In some implementations, human operators may provide or create the labeled image data.

The trained image-matching model 306 may include image feature data for the training or reference images similar to the image feature data extracted for the captured image data 302 under examination. The model 306 may also recognize symbols in the image data, such as text, machine-readable symbols (e.g., barcodes), watermarks, etc., using one or more suitable processes (e.g., optical character recognition, symbol decoding, natural language parsing).

In some implementations, the trained image-matching model 306 compares the source image feature data with the labeled image feature data to compute scores (e.g., similarity scores) which may be used to generate good or service classification labels 308 that signify one or more goods or services depicted in the image represented by the image data 302. Once the one or more goods or services have been identified, the information may be used by the situation analyzer component 140 (FIG. 1) to determine one or more objectives and/or to cause one or more suitable actions.

Referring to FIG. 3B, the audio detector 128 receives audio data 310 from a consumer processor-based device through a wired or wireless data communications channel or network. The audio data 310 may include good or service source data (e.g., a radio advertisement, audio from a TV commercial) and/or speech data (e.g., instruction, query) from the consumer 108, for example.

Using an audio feature extractor 312, the audio detector generates audio feature value data or a “fingerprint” from the audio data 310. The audio feature value data may be numerical scores that represent audio characteristics of at least a portion of the audio represented by the audio data 310. The audio features may include various perceptual characteristics, such as average zero crossing rate, estimated tempo, average spectrum, spectral flatness, prominent tones across a set of bands, or bandwidth. In some implementations, the audio feature extractor 312 is insensitive to compression algorithms, degraded quality audio, analog transmission artifacts, environmental noise, etc.

A trained audio-matching model 314 receives the audio feature data from the audio feature extractor 312. The trained audio-matching model 314 may be trained on labeled audio data pertaining to goods and services and/or pertaining to speech. For example, the trained audio-matching model 314 may be trained using labeled audio advertisement data for a number of goods and services. Such audio data may be obtained from any resource, including content delivery systems (e.g., broadcasters, webcasters), consumer processor-based devices, advertisement delivery systems, merchant systems, etc. In cases where the audio data includes audio pertaining to a consumer's voice, the trained audio-matching model 314 may be trained on a particular consumer's voice and/or trained on a plurality of consumers' voices, for example, to recognize a consumer's voice and to distinguish the consumer's voice from advertisement source data. The advertisement or consumer interest speech data may be converted into textual data using a suitable speech recognition algorithm. The textual data may be analyzed using natural language processing techniques to parse the content of the textual data.

The trained audio-matching model 314 may compare the source audio feature data to the labeled audio feature data to generate one or more classifications or labels 316 for the audio data. For example, trained audio-matching model may detect that the audio data relates to a particular type of car, a brand of ice cream, an instruction or query from a consumer, etc. The trained audio-matching model 314 may make such determination based on detected speech in the audio data and/or based on one or more other characteristics of the audio data.

In some implementations, the audio detector 128 may analyze the audio data 310 to detect both speech from a consumer and advertisement source data from a single set of audio data. For example, a consumer may speak a voice command into a microphone of a consumer processor-based device while an advertisement including sound is presented on the consumer's television. Thus, the audio data 310 may include both the consumer's voice and sounds from the advertisement. In this example, the audio detector 128 may detect both the voice command and the good or service associated with the presented advertisement.

In some implementations, the image detector 130 and the audio detector 128 may operate jointly to identify one or more goods or services and/or one or more consumer instructions or queries. The image detector 130 and the audio detector 128 may also operate jointly with other input detectors (e.g., touch screen, human motion capture device). For example, a consumer may capture an image of TV screen that depicts multiple goods and services and then speak (or otherwise input) the words “purchase the coffee mug in the lower right portion of the screen.” In this example, the audio detector 128 may convert the speech to text and identify key words or phrases, such as “coffee mug,” “lower right portion,” and “purchase.” Such information may be provided to the image detector 130 to assist with or improve the image recognition process. For instance, the image detector 130 may focus its analysis on the lower right portion of the image and may discard or filter results that are inconsistent with the phrase “coffee mug.” Similarly, the image detector 130 may provide image detection information to the audio detector 128 to assist with or improve the audio detection process.

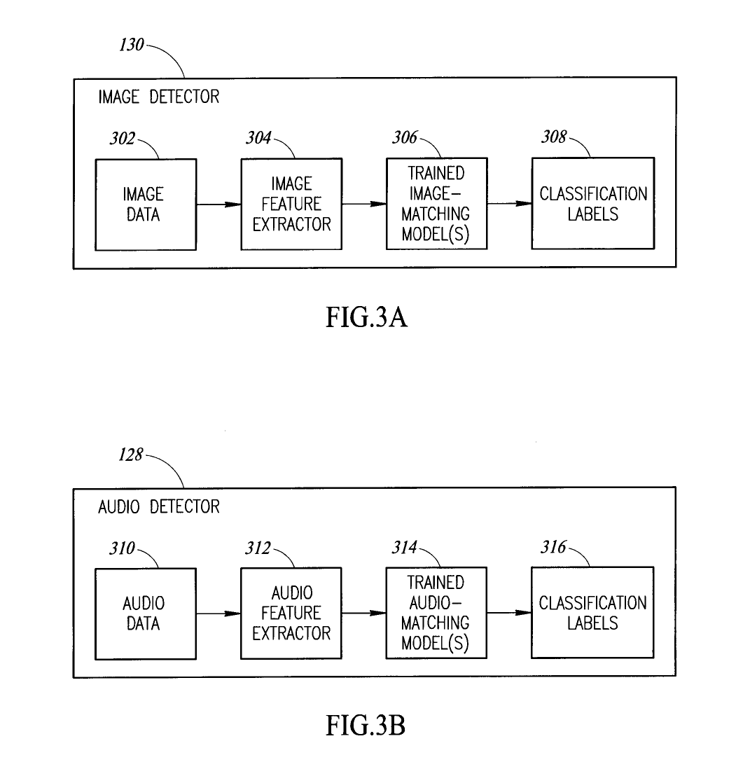

FIG. 4 shows a method 400 of operating an intelligent interactive shopping assistance system, such as the intelligent interactive shopping assistance system 100 of FIG. 1, according to one illustrated embodiment. Notably, the approach described herein provides an improved network shopping system that allow consumers to search for, locate, identify, select, pay for, and receive a good or service from a consumer processor-based device, such as a smartphone, tablet computer, etc.

The method 400 starts at 402. For example, the method 400 may start in response to an opening of a specific application or selection of an icon displayed on a display of a consumer processor-based device, such as the consumer processor-based devices 104 of FIGS. 1 and 2B or a voice command. For example, a consumer associated with a consumer processor-based device may open a specific application after becoming interested in a good or service that is currently being advertised on a television in view of the consumer.

At 404, the consumer may control the consumer processor-based device to capture source data for a particular good or service presented in an advertisement. For example, the consumer may point a camera of the consumer processor-based device at the television screen to capture one or more images of a good or service. A microphone of the consumer processor-based device may capture a soundtrack associated with the advertisement.

At 406, the consumer may input their particular interest in the good or service presented in the advertisement into a capture component of the consumer processor-based device. For example, the consumer may express their interest by speaking, touch screen input, one or more gestures or motions detectable by the consumer processor-based device, or in any other way. As discussed above, the consumer's interest in the good or service may include, for example, obtaining more information, obtaining pricing information, obtaining available discounts information, purchasing the good or service, or delivery of the good or service to the consumer.

At 408, the consumer processor-based device transmits the composite captured data including the source data and the consumer interest data to a control system over one or more wired or wireless data communication channels.

At 410, the control system processes the received composite captured data to extract or recognize both the good or service depicted in the advertisement and the captured consumer interest data, formulates consumer objectives, generates relevant requests or actions, generates relevant communications, etc.

For example, at 412 the control system may collect information pertaining to the recognized good or service from one or more local or remotely located resources (e.g., product database). Additionally or alternatively, at 414 the control system may cause the purchase of the recognized good or service based on an instruction received and detected from the consumer. In some implementations, in response to a purchase request, the control system may send purchase instructions to a merchant system that includes payment information, contact information, delivery information, or other information that is useful to complete a purchase order for the consumer.

At 416, the control system may cause relevant information to be sent to the consumer processor-based device for presentation to the consumer. In the case where the consumer requests additional information about a good or service, the control system may cause such additional information to be sent to the consumer's consumer processor-based device. If the consumer requests a purchase of a good or service, the control system may cause a purchase confirmation or receipt to be sent to the consumer's consumer processor-based device or to an address associated with the consumer.

The method 400 ends at 418 until started or invoked again. For example, the method 400 may be invoked each time a consumer takes an interest in a good or service and wishes to purchase the good or service or obtain additional information about the good or service using the interactive shopping assistance system.

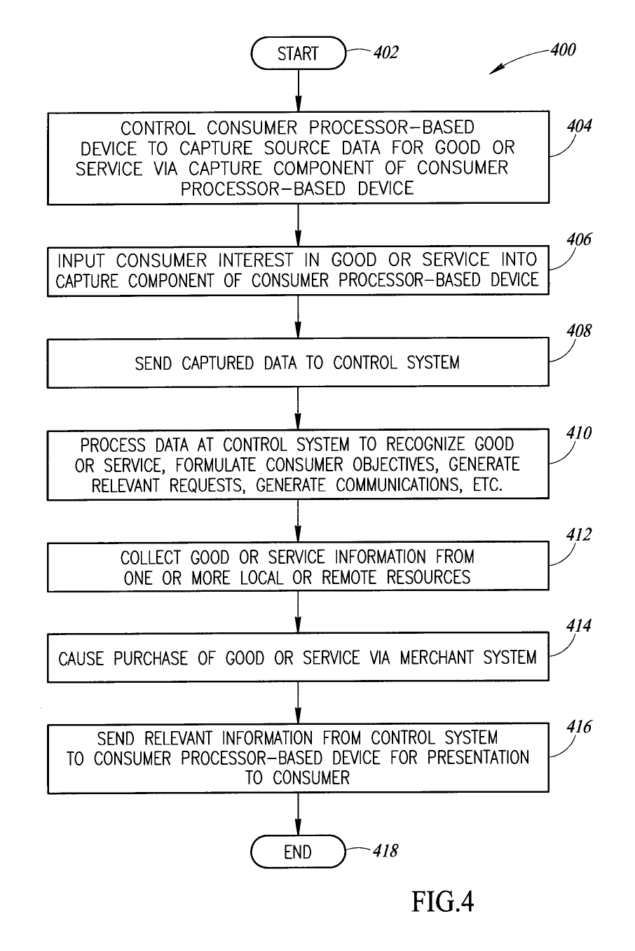

FIG. 5 shows a method 500 of operating a consumer processor-based device of an intelligent interactive shopping assistance system to capture advertisement source data and consumer interest data. The method 500 starts at 502, for example, when a consumer associated with the consumer processor-based device opens an application after becoming interested in a good or service that is currently presented to the user. The good or service may be presented visually, such as on printed media (e.g., magazine, newspaper, sign), on a display as an image or video, or as a three dimensional object (e.g., a physical product). The good or service may additionally or alternatively be presented audibly, such as through a radio advertisement or audio streaming advertisement.

At 504, the consumer may control the consumer processor-based device to capture composite source data including source data for a particular good or service and consumer interest data. At 506, the consumer may send the composite captured data to a shopping assistance control system over one or more data communications channels for processing by the control system, as described above.

The method 500 ends at 506 until started or invoked again. For example, the method 500 may be invoked each time a consumer takes an interest in a good or service and wishes to purchase the good or service or obtain additional information about the good or service using the interactive shopping assistance system.

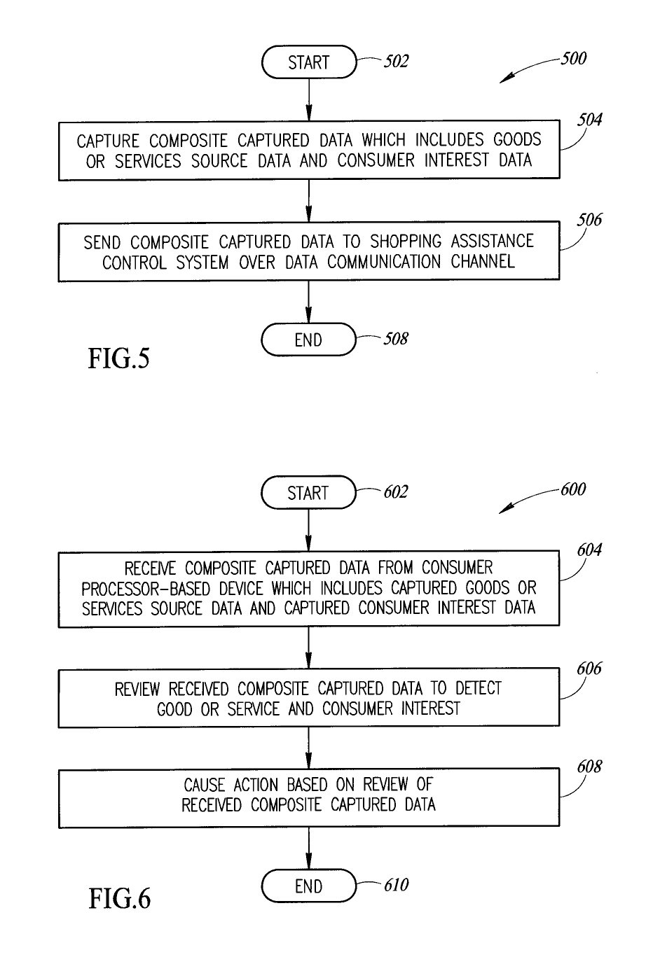

FIG. 6 shows a method 600 of operating a shopping assistance control system to provide a consumer with an intelligent interactive shopping experience. The method 600 starts at 602.

At 604, the control system receives composite captured data from a consumer processor-based device. As discussed above, the composite captured data includes both data representing a good or service as well as consumer interest data representing a particular interest of a consumer.

At 606, the control system reviews the received composite captured data to detect or recognize the good or service and to detect or recognize the consumer's interest in the good or service. Methods for reviewing or processing the composite captured data are discussed in detail above.

At 608, the control system causes an action to be performed based at least in part on the review of the received composite data. For example, the control system may cause a purchase of the good or service, or may cause information about the good or service to be sent to the consumer processor-based device for presentation to the consumer.

The method 600 ends at 610 until started or invoked again. For example, the method 600 may be executed each time a consumer causes a consumer processor-based device to send composite captured data to the control system so that the data may be analyzed and appropriate actions may be implemented.

Accordingly, implementations of the present disclosure provide an advanced shopping experience for consumers by allowing consumers to use their consumer processor-based devices to learn about and/or purchase goods or services substantially in real-time without requiring interaction with the source that presents the good or service to the consumer.

In another embodiment, a consumer processor-based device such as 104a, 104b, or 104c may incorporate the control system 102 and becoming a single integrated device with all above described functionalities.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and/or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, and U.S. patent applications referred to in this specification and/or listed in the Application Data Sheet are incorporated herein by reference in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a shopping assistance platform including at least one processor-based component having at least one nontransitory processor-readable medium communicatively coupled to the at least one processor-based component and which stores at least one of processor-executable instructions or data, the method comprising:
receiving, by the at least one processor-based component, composite captured data from a consumer processor-based device of a consumer over at least one data communication channel, the composite captured data including captured good or service (GOS) source data and captured consumer interest data, the captured GOS source data captured by the consumer processor-based device and representative of at least one of an audio signal or an image signal that indicates a good or service, the captured consumer interest data captured by the consumer processor-based device and represents an interest of the consumer in the good or service;
reviewing, by the at least one processor-based component, at least a portion of the received composite captured data to detect at least the good or service represented by the captured GOS source data and to detect the interest of the consumer represented in the captured consumer interest data; and
causing, by the at least one processor-based component, at least one of a purchasing of the detected good or service or a sending of information concerning the good or service to the consumer processor-based device over the at least one data communication channel based at least in part on the reviewing of at least a portion of the received composite captured data.

2-18. (canceled)

19. An interactive shopping assistance system, comprising:
at least one processor-based component; and
at least one nontransitory processor-readable medium communicatively coupled to the at least one processor-based component and which stores at least one of processor-executable instructions or data that when executed by the at least one processor-based component of the online shopping system, cause the at least one processor-based component to:
receive composite captured data from a consumer processor-based device of a consumer over at least one data communication channel, the composite captured data including captured good or service (GOS) source data and captured consumer interest data, the captured GOS source data captured by the consumer processor-based device and representative of at least one of an audio signal or an image signal that indicates a good or service, the captured consumer interest data captured by the consumer processor-based device and represents an interest of the consumer in the good or service;
review at least a portion of the received composite captured data to detect at least the good or service represented by the captured GOS source data and to detect the interest of the consumer represented in the captured consumer interest data; and
cause at least one of a purchasing of the detected good or service or a sending of information concerning the good or service to the consumer processor-based device over the at least one data communication channel based at least in part on the review of at least a portion of the received composite captured data.

20. The interactive shopping assistance system of claim 19 wherein the at least one processor-based component:
compares at least one of the captured GOS source data or the captured consumer interest data to reference data stored in the at least one nontransitory processor-readable medium.

21. The interactive shopping assistance system of claim 19 wherein the at least one processor-based component:
receives captured GOS source data representative of a human-intelligible audio signal; and
determines at least one textual representation of the audio signal.

22. The interactive shopping assistance system of claim 21 wherein the at least one processor-based component:
compares the determined at least one textual representation of the audio signal to reference data stored in the at least one nontransitory processor-readable medium.

23. The interactive shopping assistance system of claim 19 wherein the at least one processor-based component:
receives captured GOS source data representative of a human-intelligible image signal; and
determines at least one graphical insignia present in the image signal indicative of the good or service.

24. The interactive shopping assistance system of claim 23 wherein the at least one processor-based component:
compares the determined at least one graphical insignia to reference data stored in the at least one nontransitory processor-readable medium.

25. The interactive shopping assistance system of claim 19 wherein the at least one processor-based component:
receives captured GOS source data representative of a human-intelligible image signal;
determines one or more features of the image signal; and
compares the determined one or more features to reference features stored in the at least one nontransitory processor-readable medium.

26. The interactive shopping assistance system of claim 19 wherein the at least one processor-based component:
receives audio data representative of a voice instruction of the consumer captured by the consumer processor-based device.

27. The interactive shopping assistance system of claim 26 wherein the at least one processor-based component:
determines at least one textual representation of the audio data representative of the voice instruction; and
compares the determined at least one textual representation of the audio data to reference data stored in the at least one nontransitory processor-readable medium to identify the voice instruction of the consumer.

28. The interactive shopping assistance system of claim 19 wherein the at least one processor-based component:
receives consumer interest data obtained from the consumer via a graphical user interface component communicatively coupled to the consumer processor-based device.

29. The interactive shopping assistance system of claim 19 wherein the at least one processor-based component:
receives consumer interest data obtained from the consumer via a gesture user interface component that receives contactless human motions as input.

30. The interactive shopping assistance system of claim 19 wherein the at least one processor-based component:
sends purchase order data to a merchant processor-based device over the at least one data communication channel.

31. The interactive shopping assistance system of claim 30 wherein the at least one processor-based component:
sends at least one of contact information, shipping information, or payment information to the merchant processor-based device over the at least one data communication channel.

32. The interactive shopping assistance system of claim 19 wherein the at least one processor-based component:
sends payment information to a payment processor-based device over the at least one data communication channel.

33. The interactive shopping assistance system of claim 19 wherein the at least one processor-based component:
receives advertising source data captured by the consumer processor-based device, the advertising source data representative of human-intelligible advertising content.

34. The interactive shopping assistance system of claim 33 wherein the human-intelligible advertising content is captured by at least one of an acoustic sensor or an image sensor of the consumer processor-based device.

35. The interactive shopping assistance system of claim 19 wherein the at least one processor-based component:
receives composite captured data over at least one wireless data communication channel from at least one of a smartphone, notebook computer or a tablet computer.

36. The interactive shopping assistance system of claim 19 wherein the at least one processor-based component:
receives consumer interest data including at least one of a request for a purchasing of the good or service or a request for information concerning the good or service.

37-47. (canceled)

48. A consumer processor-based device, comprising:
at least one processor;
at least one capture component communicatively coupled to the at least one processor, and
at least one nontransitory processor-readable medium communicatively coupled to the at least one processor and which stores at least one of processor-executable instructions or data that when executed by the at least one processor, cause the at least one processor to:
cause the at least one capture component to capture composite captured data which includes good or service (GOS) source data and consumer interest data, the GOS source data representative of at least one of an audio signal or an image signal that indicates a good or service, the consumer interest data represents an interest of the consumer in the good or service; and
send the composite captured data to a processor-based shopping control system over at least one data communication channel, the processor-based shopping control system reviews at least a portion of the composite captured data to detect at least the good or service represented by the captured GOS source data and to detect the interest of the consumer represented in the captured consumer interest data.

49. The consumer processor-based device of claim 48, further comprising:
at least one output component, wherein the at least one processor:
receives from the processor-based shopping control system at least one of a purchase confirmation for the good or service or information concerning the good or service over the at least one data communication channel based at least in part on the review of at least a portion of the composite captured data by the processor-based shopping control system; and
presents the received at least one of a purchase confirmation or information concerning the good or service via the output component.

50. The consumer processor-based device of claim 48 wherein the at least one capture component comprises an audio capture component, and wherein the at least one processor:
causes the audio capture component to capture a human-intelligible audio signal produced by an acoustic output component of a media player device as the GOS source data.

51. The consumer processor-based device of claim 48 wherein the at least one capture component comprises an audio capture component, and wherein the at least one processor:
causes the audio capture component to capture a spoken sound of the consumer as the consumer interest data.

52. The consumer processor-based device of claim 48 wherein the at least one capture component comprises an image capture component, and wherein the at least one processor:
causes the image capture component to capture at least one image as the GOS source data.

53. The consumer processor-based device of claim 48 wherein the at least one capture component comprises a graphical user interface component, and wherein the at least one processor:
causes the graphical user interface component to capture consumer interest data.

54. The consumer processor-based device of claim 48 wherein the at least one capture component comprises a gesture user interface component that receives contactless human motions as input.

55. The consumer processor-based device of claim 48 wherein the at least one processor:
sends an identifier to the processor-based shopping control system over at least one data communication channel, the identifier pertaining to at least one of the consumer or the consumer processor-based device.

56. The consumer processor-based device of claim 48 wherein the at least one capture component comprises an image capture component, and wherein the at least one processor:
causes the image capture component to capture at least one of an image of a display of a processor-based device, an image of an object, or an image of printed media.
